(19) United States
(12) Patent Application Publication
(10) Pub. No.: US 2014/0373173 A1
(43) Pub. Date: Dec. 18, 2014

(54) METHOD FOR REQUIRING USER ACTIONS FOR THE ACCESS OR DELIVERY OF ITEMS OF VALUE

(71) Applicant: Clarence N. Baker, II, Oakland, CA (US)

(72) Inventor: Clarence N. Baker, II, Oakland, CA (US)

(21) Appl. No.: 14/308,622

(22) Filed: Jun. 18, 2014

Related U.S. Application Data
(60) Provisional application No. 61/836,606, filed on Jun. 18, 2013.

(51) Int. Cl. G06F 21/10

(52) U.S. Cl. CPC G06F 21/10
USPC 726/27

(57) ABSTRACT

The present invention is directed to a method for providing items of value to consumers, and more specifically is a method that provisions access to items as the result of consumer action. Methods are provided that: 1) allow an administrator do define actions which must be performed by a user to obtain access to items; 2) validate that the actions have been performed by the user; and 3) provide access to the items. The present invention permits content producers to easily increase the value of their content, grow their audience, drive consumer engagement, improve data quality and increase revenues. The invention also permits consumers to more fairly exchange value for their social and commerce-related transactions.

### CROSS-REFERENCE TO RELATED APPLICATIONS

This application claims the benefit of U.S. Provisional Application No. 61/836,606, filed Jun. 18, 2013, the contents of which are hereby incorporated by reference in its entirety.

### BACKGROUND OF THE INVENTION

### Field of the Invention

Current business models and widely used technologies for accessing or delivering content over the Internet have several flaws. Thus, for example, despite attempts to limit access to digital files, such as music, videos, or books, piracy is rampant and content producers are often not adequately compensated for their efforts. This as the additional undesired effect of suppressing the quality of available content. In addition, audiences (the “consumers”) are not properly incentivized or rewarded for performing social activities which are sometimes required for access to the content, such as completing registration forms, or recommending or purchasing an item. This suppresses consumer social activity, registrations, referrals and purchase.

In addition, the business model of social networking sites provides the bulk of the financial benefit to the site itself. Thus, for example, there have been examples of users posting high quality photos on social networking sites. Although the photographs may receive millions of views, the sites receive all of the financial compensation resulting from such photos by selling data to advertisers and placing ads around the photo.

Further, technological innovations for the delivery of content delivery are largely suppressed by multinational technology and media companies, presumably in an attempt to maintain the status quo of their particular business model such as, for example, free content delivery subsidized by advertising dollars. In some instances free content delivery restricts the contextual effectiveness of content delivery—that is, delivery of the right content to the right person at the right time on the right device. It may also suppress the availability of professional content distribution channels, which reduces the quality, value and compensation model of professional content because of the oversupply or lack of filtering of non-professional content. Each of these factors limits market growth.

While some attempts have been made to encourage consumer participation in the legal spread of content, these have been rather limited. Thus, for example, Facebook includes provisions to access items of value as the result of consumer action. This is referred to as “fan-gating.” Facebook, for example, provisions access to digital coupons if a consumer “likes” a fan page. This method is restricted to Facebook users and is limited to the “Like” action. Currently there is no method that permits producers to customize the consumer action, the item of value access/delivery method or the index that ranks the transaction.

Thus there is a need in the art for a method that permits for more control of the distribution of content over the Internet. Such a method should allow the content producer to decide how much access is to be provided to content and to do so in a way that facilities the distribution of content in a controlled manner.

### BRIEF SUMMARY OF THE INVENTION

The present invention is directed to a method for providing items of value to consumers, and more specifically is a method and device that provisions access to items as the result of consumer action. This invention is sometimes referred to herein as “Blazestage.”

Embodiments of the present invention provide a system that automatically validates one or more consumer actions, provisions access to items of value and indexes transactions into a rank. Blazestage permits producers to easily increase the value of their content, grow their audience, drive consumer engagement, improve data quality and increase revenues. Blazestage also permits consumers to more fairly exchange value for their social and commerce-related transactions.

The present invention overcomes the disadvantages of prior art, in part, by providing a platform on which a content producer may provide content to users in a way that encourages users to share content with others while maintaining some level of control over the user's access to the content.

In certain embodiments, a method is provided that enables celebrities, businesses or artists (the “producers”) to provide music, videos, documents, information, merchandise, e-commerce shipping tracking receipts and/or performance tickets (the “items”) to the public (the “users” or “consumers”). Thus, for example and without limitation, examples are provided that include methods for celebrities to provide exclusive access to information to fans as the result of taking certain actions on social network sites.

In one embodiment, a method for use by a content provider or content producer, in the person of an “administrator,” to define a mission which, when completed by a user, delivers content to the user, is provided. The method includes: prompting the administrator to identify two or more actions to be performed on two or more platforms; prompting the administrator to identify content to be provided to the user upon completion of the two or more actions; and generating code that, when executed by the user, prompts the user to perform the identified two or more actions, verifies that the user has performed the identified two or more actions, and provides the user with access to the identified content.

In yet another embodiment, a method for verifying actions taken by a user is provided. The method includes: prompting a user to perform two or more actions on two or more platforms; and verifying that the user has performed the two or more actions.

In certain other embodiments, a method for delivering content over a network is provided. The method includes: prompting a user to perform two or more actions on two or more platforms; and providing content to the user after the user has performed the two or more actions.

These features together with the various ancillary provisions and features which will become apparent to those skilled in the art from the following detailed description, are attained by the method of the present invention, preferred embodiments thereof being shown with reference to the accompanying drawings, by way of example only, wherein:

### BRIEF DESCRIPTION OF THE SEVERAL VIEWS OF THE DRAWING

FIGS. 1A and 1B are schematics illustrating one embodiment of a system for managing content;

FIGS. 2A through 2I are screen shots illustrating the use of the invention by an administrator to generate an embed code for a mission, where FIG. 2A shows an introductory screen, FIG. 2B′ and FIG. 2B″ show screens for creating a mission, FIG. 2C shows a screen after the administrator has selected mission actions, prompting for the inclusion of content, FIGS. 2D and 2E show screens that permit the administrator to add content from their own library that a user will have access to upon completion of the mission, FIG. 2F shows a screen that permits the administrator to select a mission name and exit the generation of the mission, FIG. 2G shows a screen that permits the administrator to change the look and feel of the mission, FIG. 2H shows a screen that permits the administrator to further customize the mission, FIG. 2I shows a screen that permits the administrator to re-define the mission;

FIGS. 3A through 3D are screen shots that illustrate what a user would see on screen 117 when executing a mission, where FIG. 3A shows a screen shot prior to executing the mission, FIG. 3B shows a screen shot providing mission information to the user, FIG. 3C shows a screen shot during the mission, and FIG. 3D shows the unlocked content available to the user after completing the mission;

FIGS. 4A through 4C are screen shots illustrating embodiments that may be used for an administrator to set up a mission, where FIG. 4A shows a screen shot that prompts the administrator to define a step of a mission, FIG. 4B illustrates the setting up of a “Share” mission, and FIG. 4C illustrates constraints that an administrator may put on the provided content; and

FIGS. 5A through 5E are screen shots illustrating embodiments that may be used for a user to execute a mission and gain access to locked content, where FIG. 5A is illustrative of a screen that is presented to a user, FIG. 5B shows that the user requested to share on a social networking site, FIG. 5C shows a competed mission and unlocked content, FIG. 5D shows a prompt for the user's e-mail, and FIG. 5E shows the unlocked content being received as an e-mail by the user.

Reference symbols are used in the Figures to indicate certain components, aspects or features shown therein, with reference symbols common to more than one Figure indicating like components, aspects or features shown therein.

### DETAILED DESCRIPTION OF THE INVENTION

Certain embodiments of the present invention control access to content by allowing a content provider or content producer, in the person of an administrator, to define a “mission” of one or more actions or steps that a user must perform in order to gain access to the content. Thus for example, the administrator may define a mission which is presented to the user as an enticement on a web page that, upon completing the steps of the mission, they will be provided with access to certain content, including but not limited to, music or image files. Thus, for example, the user may be initially provided with publically accessible content and, upon completion of a mission, the user may be provided with private content whose access is controlled by the administrator. In certain other embodiments, the mission steps require that the user make the availability of the content known to other people, and added additional content if a certain total number of users complete the mission. In this way, the method and system entices greater distribution of content.

In certain other embodiments, the user is provided with mission actions that are verifiable by an inventive verification system. Thus, for example, the result of the administrator defining a mission is a web page that points to the verification system and which contains possible actions which must be performed to unlock content for the user. The actions may be, for example and without limitation, actions on a social networking site (such as Liking on Facebook) or downloading a song from iTunes. As the user performs the various actions, the verification system confirms that the actions have indeed been performed. Verification may, for example and without limitation, include, accepting requested personal information from the user, the execution of software on the user's computer to verify that certain songs are stored on the user's computer, and/or having the user authorize that information be sent from a third site, such as the user authorizing Facebook to send user Like information to the verification system.

In certain embodiments, the mission to be completed by a user may include one or more steps of a social networking activity, an e-commerce activity, or which may require the user to provide certain information. Examples of mission steps include, but are not limited to, a retweet on Twitter, a like on a Facebook page, the purchase a song on iTunes, the inclusion of a hashtag in a tweet, etc., of the public and/or private “items” involved in the mission. The mission may then allow access by the user to the content for a certain period of time, or for a certain number of accesses, once a mission has been authenticated (or completed).

The present invention may thus provide a real-time, cross-platform authentication of the mission steps to allow the user to access secure media file based on social or ecommerce activities, as required by the mission.

Thus for example, the system confirms completion of a mission by authenticating that a user shares content on a certain Facebook page or retweets a Tweet, purchase a certain item on iTunes, use a certain hash tag inside a Tweet, or registers on a certain website, or answers certain questions.

Once a mission is complete, the content may be unlocked as defined by the administrator for a single use, for multiple uses, or for unlimited uses.

In certain other embodiments, proprietary, embeddable media players, or full web pages, integrate the data capture, social engagement and content delivery into an entertaining, two-click process. This provides a mutual benefit: it drives up the value of content to producers, by increasing engagement, and rewards engagement to audiences. Blazestage is a multi-tiered, open-platform and device-agnostic networked application.

In yet other embodiments, the present invention offers enterprise-class analytics, or big data, on user activity for those that create missions, regardless of the content hosting provider (e.g. YouTube, Soundcloud, UStream or Blazestage). This is novel, in that it introduces the “personal social engagement platform” that enables anyone to capture, analyze and own audience activity on their content, and provide real-time social feeds on their website or blog.

In other embodiments, software is provided that may run on a mobile device, including but not limited to portable computers, smart phone, or a tablet PC. Specific embodiments may, for example, be executable on an iPhone, iPod Touch, or an iPad. The implementation may include one or more software applications that may in turn be comprised of one or more “modules.”

The various embodiments improve content delivery by providing: a) the ability to increase the value of content to the producer; b) rewards to audiences for engagement; and c) effortless integration with existing media and technology platforms. By solving many unmet needs, the present invention expands the market size of many sectors and increases the rate of profitability.

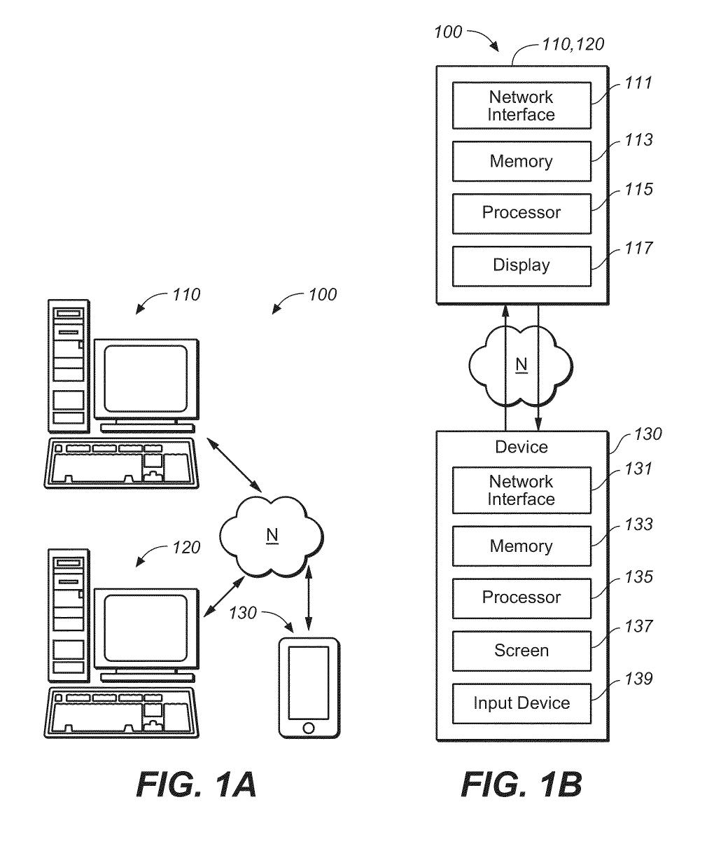

FIGS. 1A and 1B are illustrative schematics of one embodiment of a system 100 including a first server 110 for managing content, one of a plurality of second servers 120 which may host social media or e-commerce sites, and one of a plurality of user devices 130, which communicate over a network N. In one embodiment, device 130 is a wireless device, and network N includes wireless communication to the device. In general, server 110 may produce programming instructions, files, or data that may be transmitted over network N to authenticate actions that are monitored by second servers 120, and which may produce programming instructions, files, or data that may be transmitted over network N to device 130.

In general, a user of a device 130 may communicate over network N to server 110, which includes programming to receive and transmit information with device 130. Certain embodiments of the programming of device 130 allow a user of the device to perform certain actions which are monitored by server 110 via communication with servers 120, and which can then provide unlocked content to device 130.

Server 110 is a computer or computer system that includes a network interface 111, a memory 113, a processor 115, and a display 117. Is to be understood that network interface 111, memory 113, and processor 115 are configured such that a program stored in the memory may be executed by the processor to accept input and/or provide output through network interface 111 over network N to device 130.

Servers 120 are computer or computer systems that host social networking or e-commerce sites.

Device 130 may be, for example and without limitation, a user device such as a cellular telephone or a portable digital assistant includes a network interface 131, a memory 133, a processor 135, a screen 137, and an input device 139. Network interface 131 is used by device 130 to communication over a wireless network, such as a cellular telephone network, a WiFi network or a WiMax network, and then to other telephones through a public switched telephone network (PSTN) or to a satellite, or over the Internet. Memory 133 includes programming required to operate device 130 (such as an operating system or virtual machine instructions), and may include portions that store information or programming instructions obtained over network interface 131, or that are input by the user (such as telephone numbers or images from a device camera (not shown). In one embodiment screen 137 is a touch screen, providing the functions of the screen and input device 139.

In one embodiment, server 110 allows administrators to set up a mission, verified by communication with servers 120, and to provide access to “locked” content on device 130. As described herein, server 110 may perform two functions. The first function of server 110 is mission definition. This includes the running of software that allows the administrator to define the actions of a mission, identify what content is to be provided upon completion of the mission, and the generation of mission code (which may be, for example and without limitation, accessible via a URL) which is accessible by the user to execute the mission. The second function of server 110 is the validation function, wherein the server acts as a validation system. In certain embodiments, the mission code points to server 110. When the user executes the mission code, the validation system compares required actions with data in the validation system, data gathered from the user's computer, and data gathered from third party sites to confirm that the mission actions have indeed be performed. In another embodiment, the first function (mission definition) and the second function (verification) may be performed on different, networked computers.

Thus, in one embodiment, an embed code is provided to device 130 that points to a mission on server 110. The embed code may, for example, be provided on an administrator's website, or on a social media page. When users click on an image on screen 137 provided by the embed code, programming on server 110 prompts the user through the mission requirements. The mission may consist of one or more actions required for unlocking content. Once the mission is accomplished, server 110 provides unlocked content to device 130. In an alternative embodiment, the unlocked content may reside on another networked computer system. The user may view and/or download the content, as provided by the administrator.

Server 110 may then provide authentication of mission accomplishment by communication with one or more platforms (social networking or e-commerce sites) and thus provides real-time cross-platform authentication to access a secure media file based on social or ecommerce activity. Authentication is via an encrypted server-to-server message.

The content which is unlocked for access to the user upon completion of a mission includes, but is not limited to, image files, audio or video files, or ZIP archives or other binary data. Access to unlocked content on device 130 is granted by server 110 upon completion of a mission, as determined by authentication of one or more required actions on servers 120, and which may include, for example and without libation, one or more of the following Authentication Action Requirements (AAR) using the indicated verification method (API, etc.):
Social Media Actions:

Share on Facebook—Facebook API

Tweet—Twitter API

Follow on Twitter—Twitter API Retweet—Twitter API

Hashtag—Twitter API Download—Internal

iTunes—file download authentication via metadata

Comment—Internal

Registration—Internal

Completion of poll or survey—Internal
E-commerce actions:

Authorization ID from a purchase receipt Promotional code

iTunes purchase and download

Shipping tracking ID

In general, various embodiments provide a method in which may accomplish one or more of the following:

The administrator defines the mission and content to be provided on server 110 by selecting the AAR (Share my page, Buy my song on iTunes, etc.) through a GUI which stores the AAR value, and the content which is accessible at the successful completion of the mission.

The end-user navigates, on device 130, to a page that contains embed code that points back to server 110. Device 130 may, for example, request access media file (I want to play, view, download) through a provided GUI, which sends a request to server 110

As the user navigates through the mission, the required AAR is returned (Share my page, Buy my song on iTunes, etc.)

Depending on the AAR, the user is prompted to accept the social API or the system sends a message from the client to the server validating the action.

Once the AAR is validated, the user gains permission to access the unlocked media through, for example, a proprietary media player.

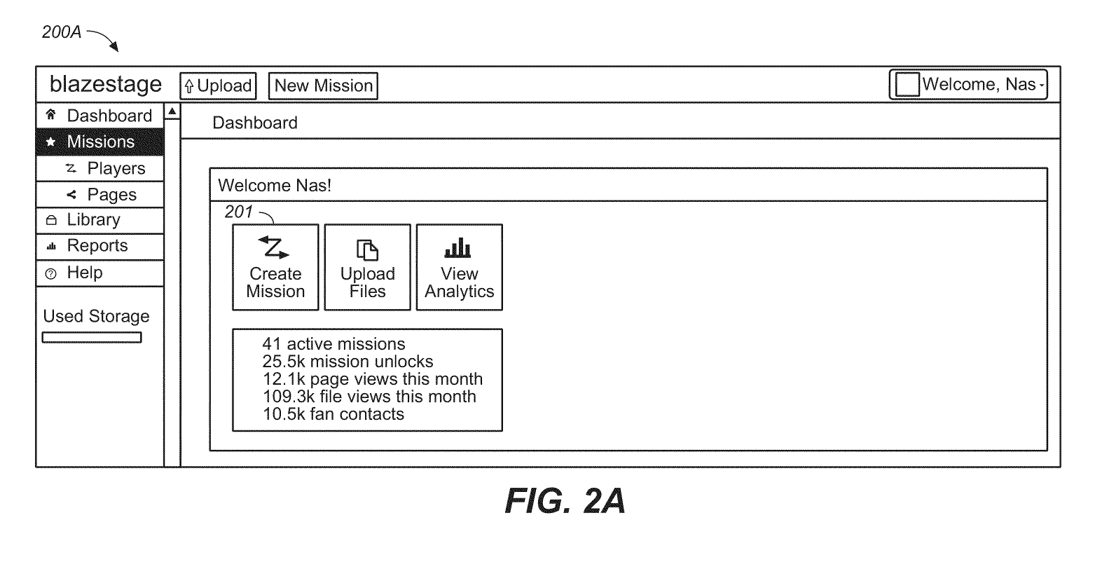

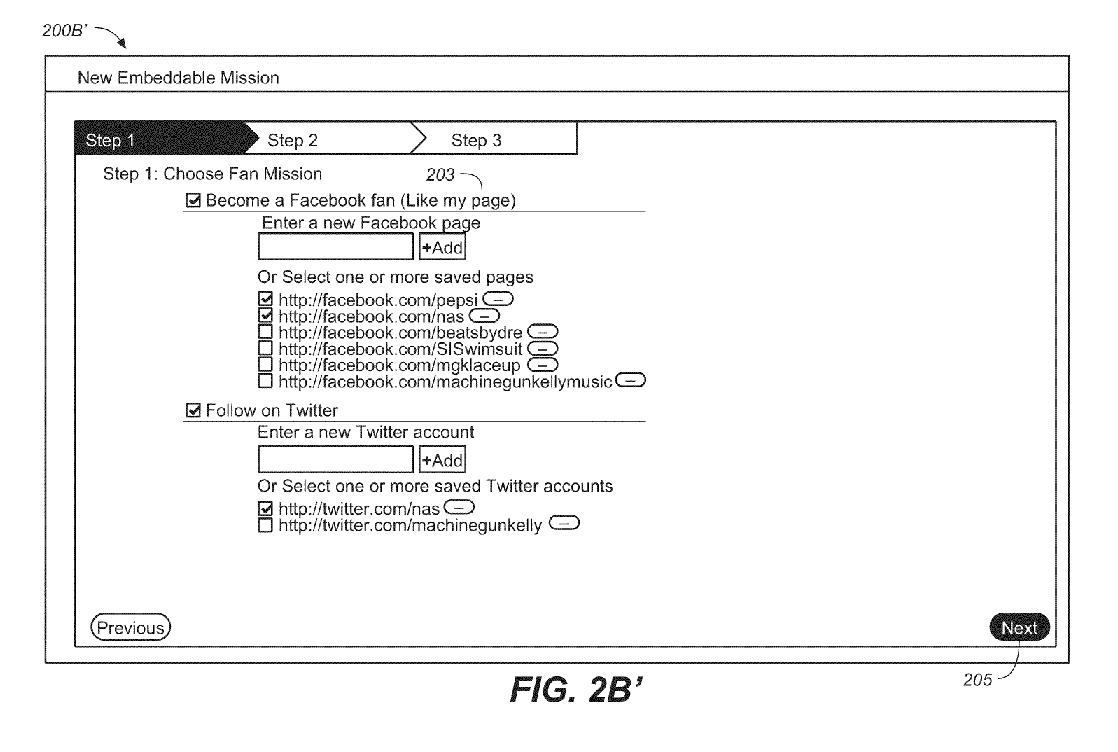

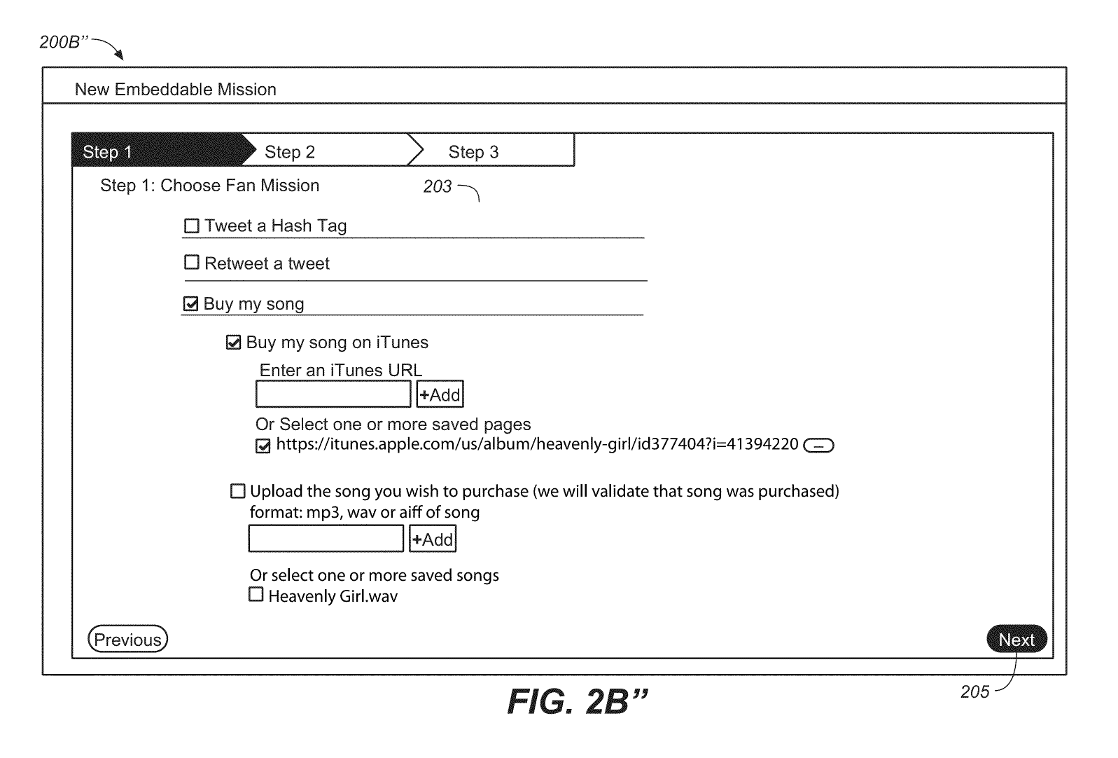

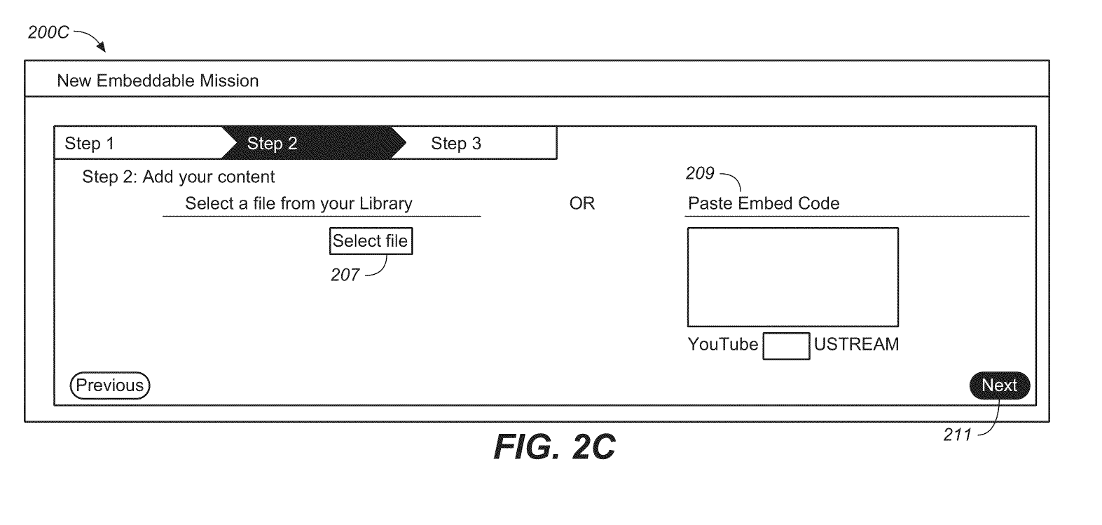

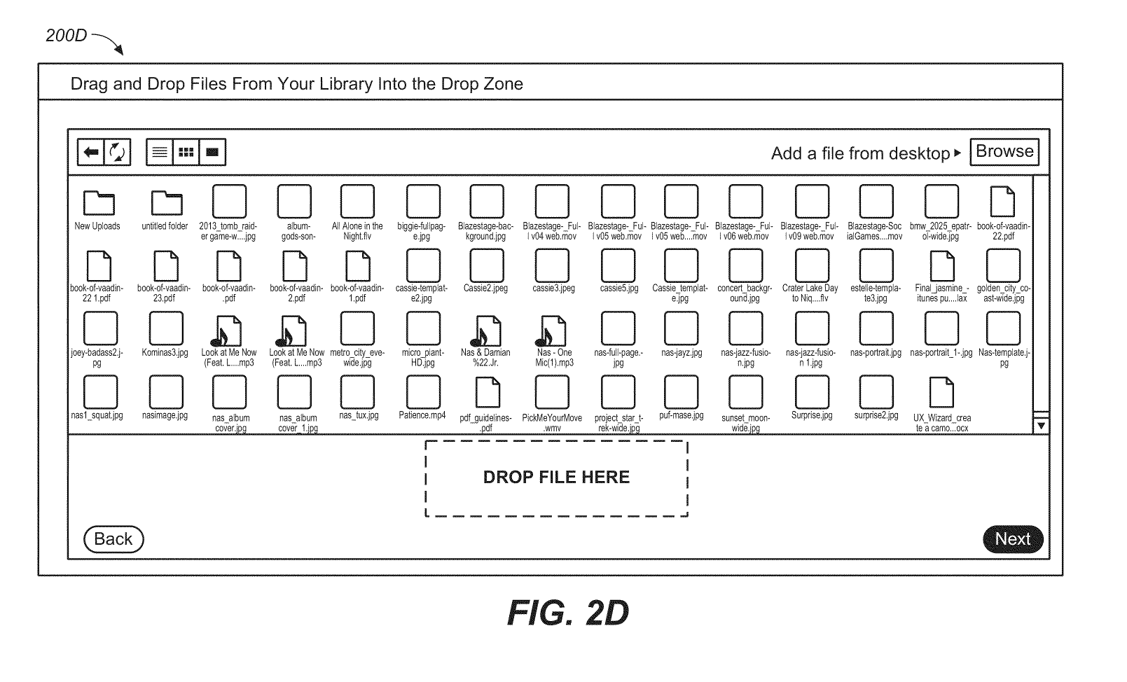

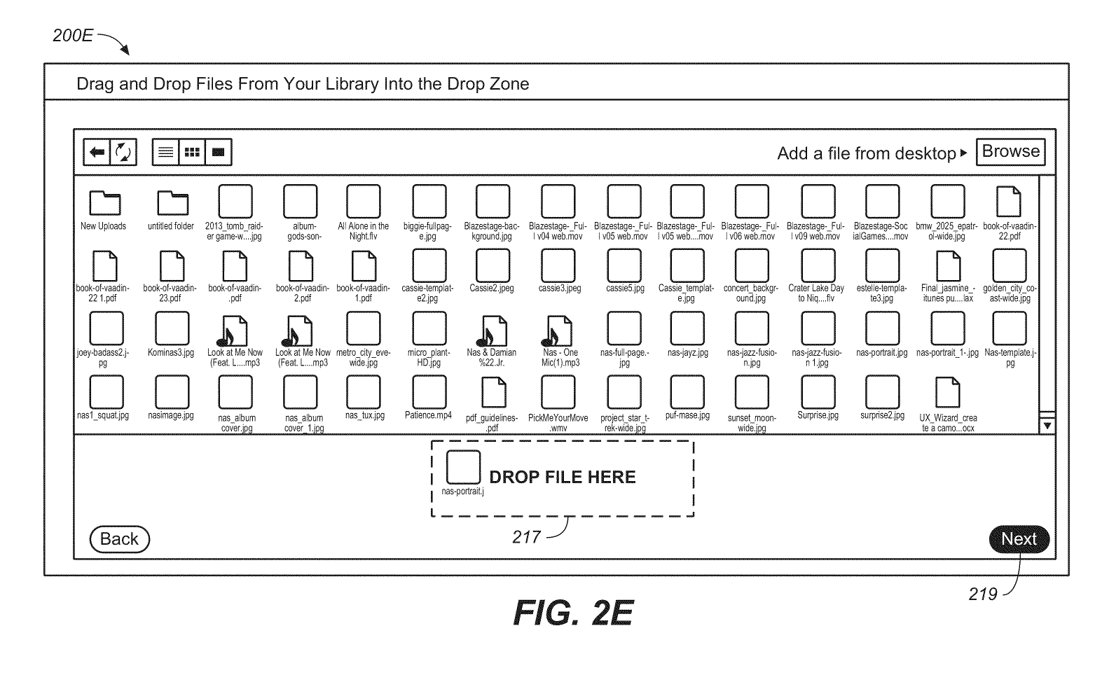

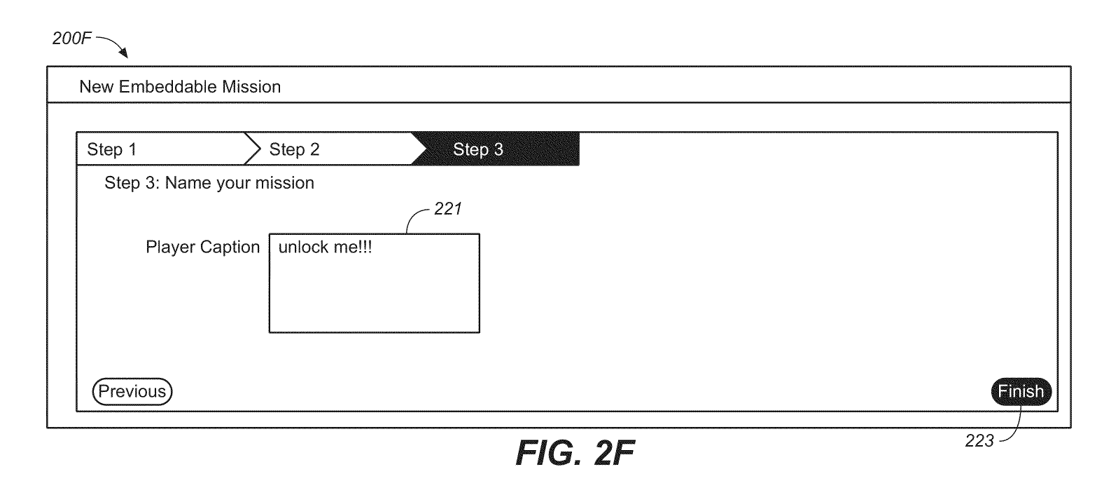

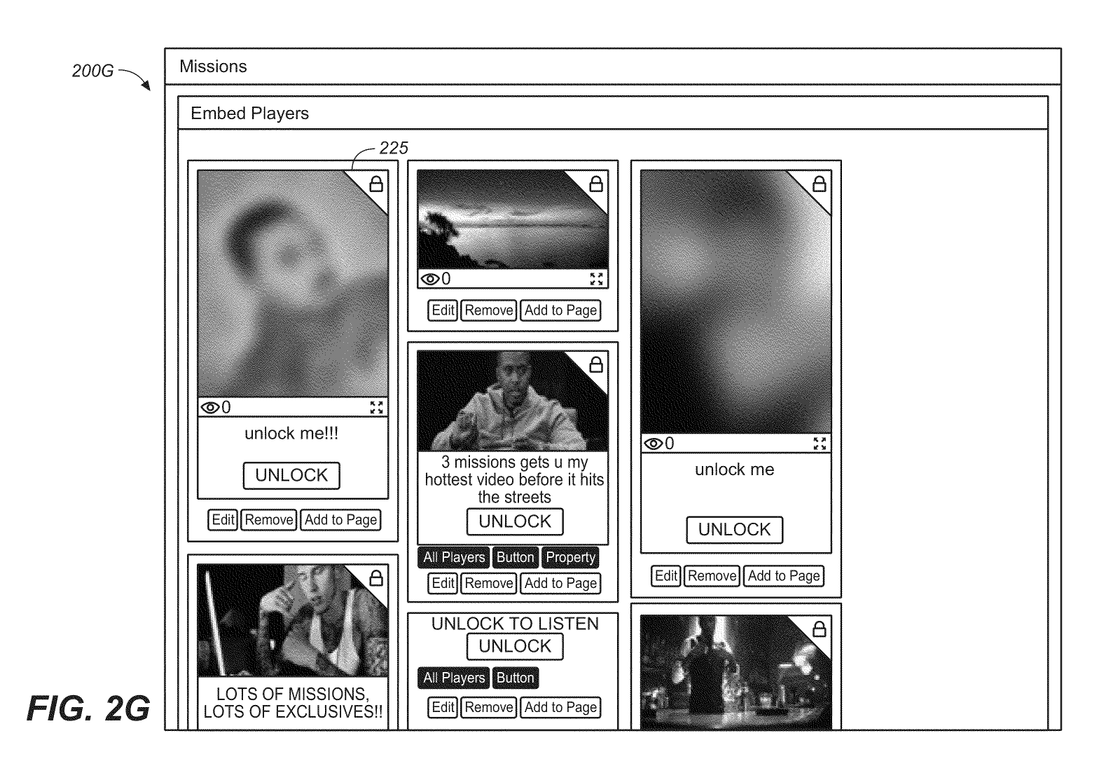

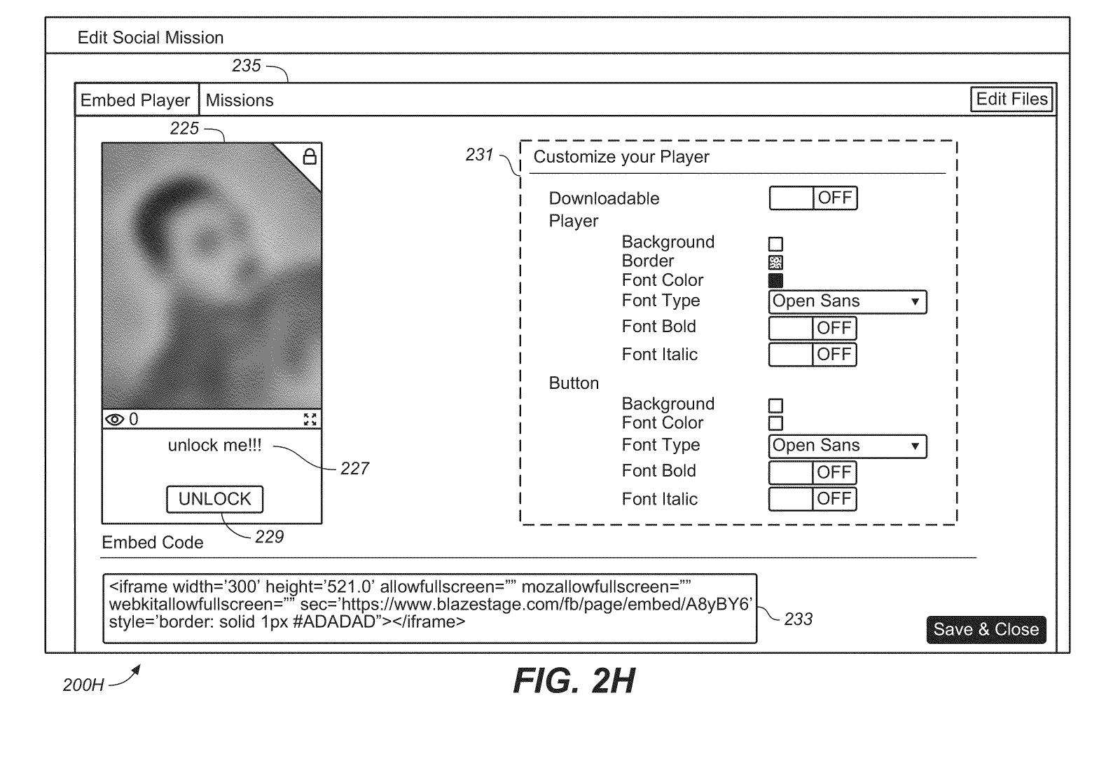

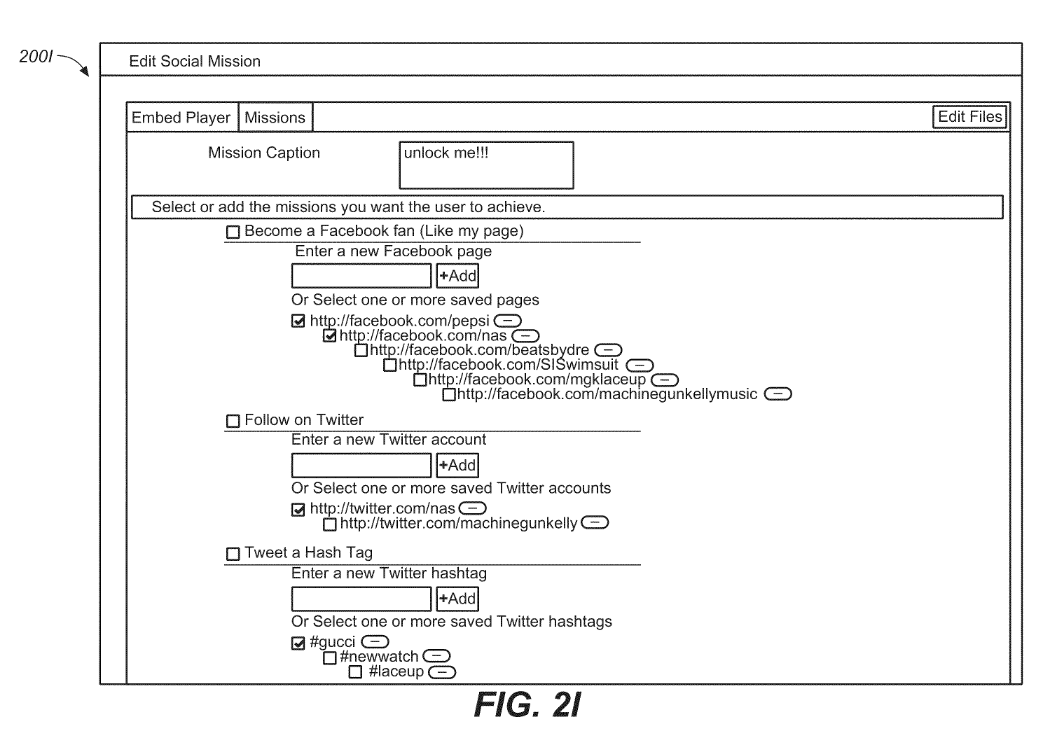

FIGS. 2A through 2I are screen shots of screen 137 of device 110 generated by software which prompt for administrator input to generate an embed code for a mission, where FIG. 2A shows an introductory screen, FIGS. 2B′ and 2B″ show screens for step 1 in creating a mission, FIG. 2C shows a screen for step 2 in creating a mission, FIGS. 2D and 2E show screens that permit the administrator to add content that will be provided to the user upon completion of the mission, FIG. 2F shows a screen that permits the administrator to select a thumbnail image for the content, FIG. 2G shows a screen that permits the administrator to select a mission name and exit the generation of the mission, FIG. 2H and 2I are screen shots prompting for administrator input to edit the look, feel, and content of the mission;

Device 110 includes software for creating a mission, uploading files, which may include content, and analytics related to missions. FIG. 2A is an introductory screen 200A for the creation of a mission which includes a button 201, which is labeled “Create Mission.”

After clicking on button 201, device 110 generates screen shot 200B′ and 200B″. From screen shots 200B′ and 200B″, the administrator is provided with a selection of activities for creating a mission, also referred to herein as a “fan mission.” The individual mission activities (also referred to herein as “mission steps”) may include, for example and without limitation, activities such as “Share on Facebook” “Like my Facebook page,” Retweet,” “Follow on Twitter,” “Tweet a Hash Tag,” “Complete Registration,” “Buy my song on iTunes,” “Buy my product on Amazon,” “Verify an on premise point of sale transaction via remote access,” etc. The administrator may select one or more of such activities as indicated by the check boxes on screen shot 200B′ or 200B″.

By way of example, screen shots 200B′ and 200B″ show that the administrator has selected four pre-selected actions, or mission steps: becoming a Facebook fan of two Facebook pages, following one Twitter account, and buying a specific song on iTunes. Alternatively, the administrator could have supplied information, such as Liking a Facebook page having an address that isn't already stored on server 110, or purchasing a song that was uploaded from a source other than iTunes.

With the mission steps thus defined, in this case requiring three separate actions (two Facebook “Like” and one Twitter follow) and after clicking “Next,” (button 205), the administrator is prompted to add content, as shown, in FIG. 2C, on screen shot 200C.

As shown on screen shot 200C, the administrator is presented with the option of selecting content provided upon completion of the mission by providing content from a library on server 110, by pressing button 207, or by pasting an embed code to content on a different networked computer, as indicated in space 209. In this example, the administrator clicks “Select File” to bring up the next page.

After clicking “Next,” (button 211), the administrator is next presented with the option of providing content from a library on server 110, as indicated on FIG. 2D in screen shot 200D. The content is indicated by thumbnails 213, or by uploading a new file from their computer by clicking, on “Add a file from desktop.” (Button 215). As discussed above, the content may be image files, audio or video files, pdf s or any other sort of content.

FIG. 2E shows screen shot 200E, wherein a thumbnail image and dragged and dropped it into the “Drop File Here” location, indicated as space 217.

Prior to completing a mission, the user is provided only with an indication of the content. Thus, for example and without limitation, a placeholder for the image may be provided by blurring the image, as may be automatically generated using ImageMagick open source photo encoding software (http://www.imagemagick.org/); a placeholder for an external link to a URL may include a title and an image from the target link based on the open graph meta tags or a generic link icon; a placeholder to a YouTube embed code may be the poster image from YouTube (using the YouTube video identifier), and a fake play button. Upon completion of the mission, actual content or links to the actual content are provided to the user, as discussed subsequently.

After clicking “Next,” (button 219), screen shot 200F, shown in FIG. 2F is presented to the administrator. From screen shot 200F, the administrator provides a name for the mission into area 221 and selected “Finish” (button 223).

With the mission and content now defined, the administrator may edit the design, styles and content of the mission and content, as shown in the next screen shots (FIGS. 2G, 2H, and 2I). As shown in screen shot 200G in FIG. 2G, all of the missions are shown, with the newly formed mission 225 in the upper-left corner. The content of mission 225, which is an image file, is blurred in its “locked” state. If the content were an audio or video file, an essentially “grayed-out” image would be presented.

Selecting the upper left image of mission 225 next causes screen shot 200H of FIG. 2H to appear. Screen shot 200H which shows detail of how a user will see the mission on their browser. (Note the name “unlock me!!!”(indicated as 227), and the “unlock” button (indicated as 229) which will start the mission.) The administrator may customize the media player for the content, as shown on the right side of the page (area 231). On the bottom screen shot 200H is an embed code 233 for the content and its mission. Embed code 233 may be copied and pasted to any page that the administrator wishes, including, for example and without limitation, their own website or a social media page.

If the administrator selects “Missions” tab 235, they are then provided with options to modify the mission, as shown on screen shot 200I of FIG. 2I. This is similar to screen shot 200B, and allows for the administrator to edit the mission.

Once the mission is thus defined, a URL is generated so that a user can access the mission from sever 110 or 210.

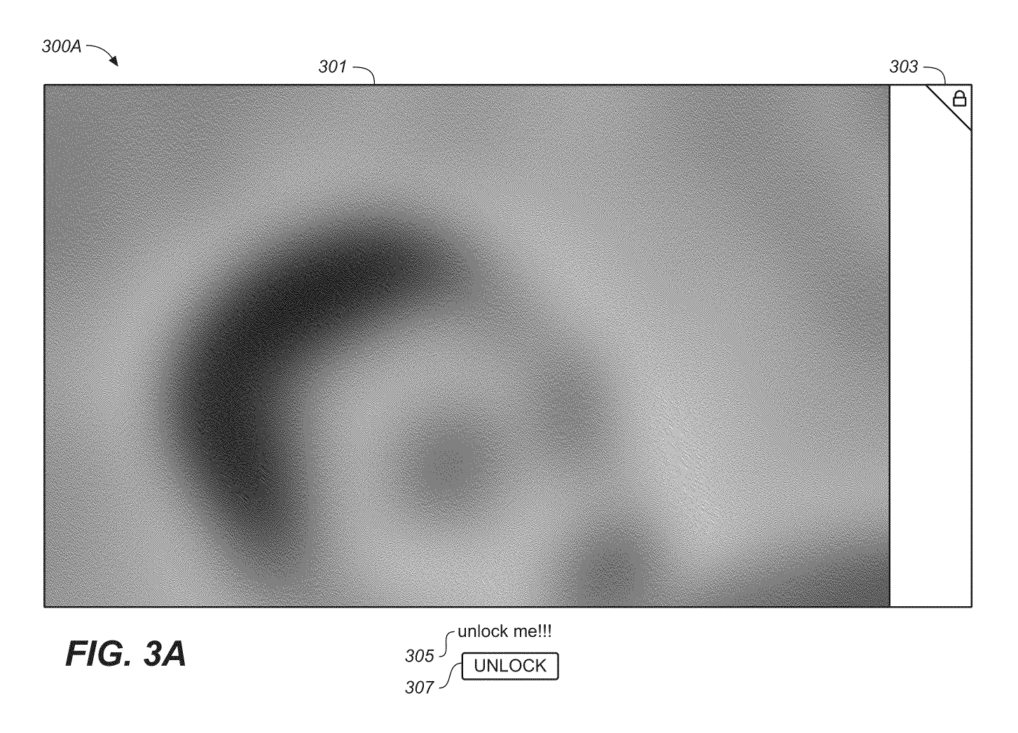

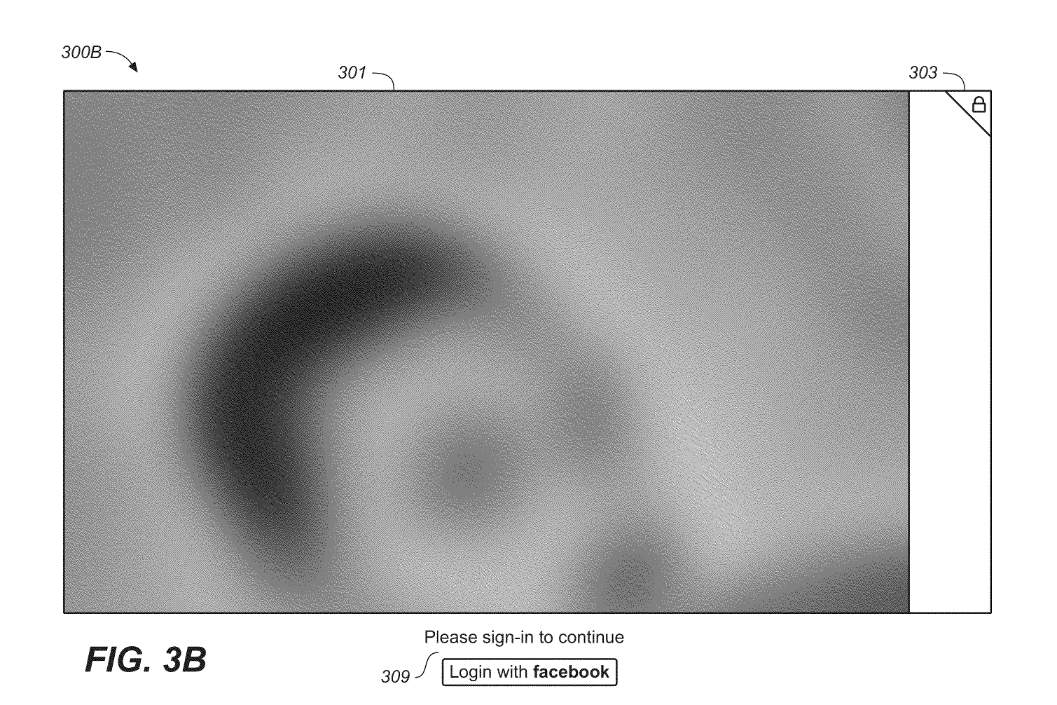

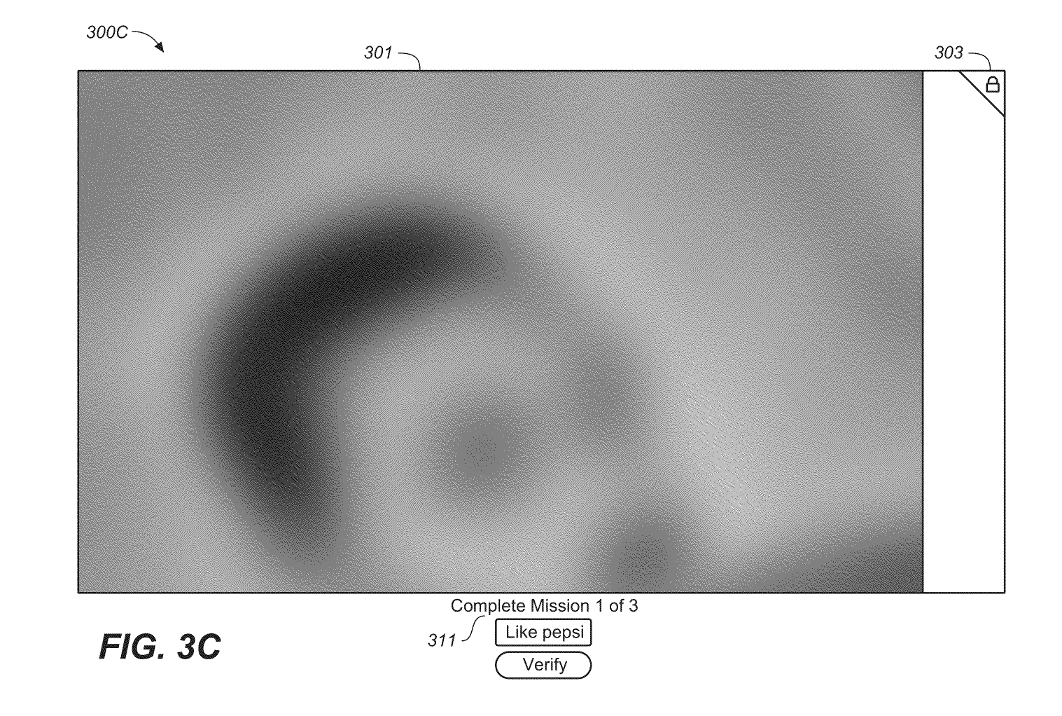

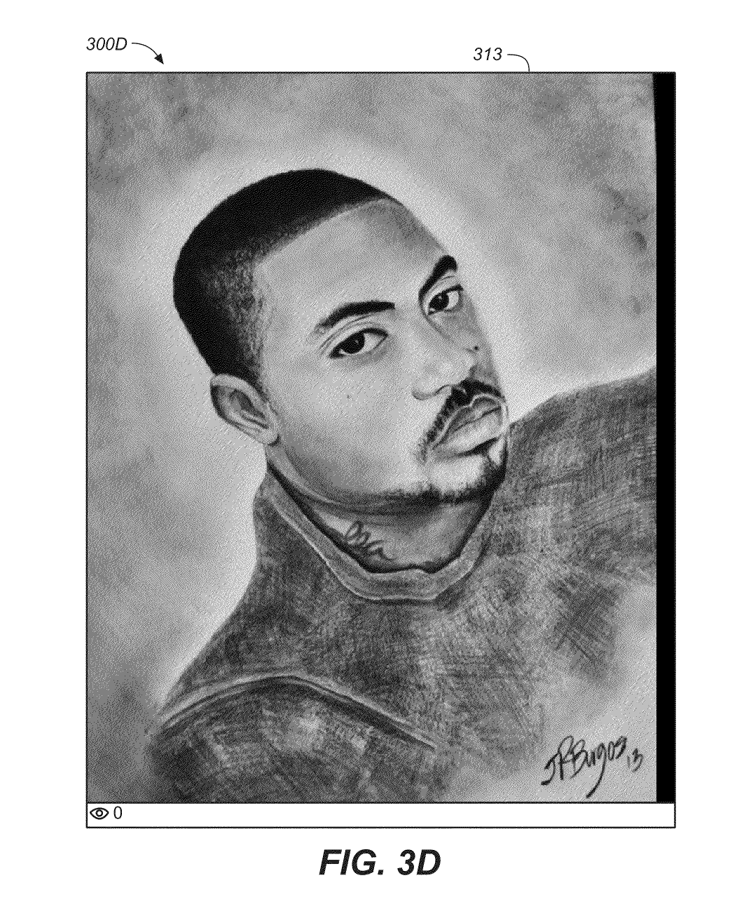

FIGS. 3A, 3B, 3C, and 3D contain screen shots 300A, 300B, 300C, and 300D, respectively, which illustrate what a user might see on screen 117. A user enters the URL for the mission into their browser. Next, the screen shot 300A appears, showing the locked media 301 (a grayed out image in this example), a locked symbol 303 in the upper right hand corner, the title 305, and an “Unlock” button 307.

When “Unlock” button 307 is selected, screen shot 300B is presented on screen 117. The one or more mission element and instructions 309 appear below the content. Thus, for example, the user of device 120 may be provided with sequential instructions to log onto a cite, to “Like,” tweet, purchase on iTunes, answer survey questions, or to preform whatever actions are defined by the administrator in the previous steps. The number of actions required to unlock content are defined by the number of actions required in the mission, as set up by the administrator. The next two shots show prompting for signing onto Facebook and Liking the Pepsi page.

As illustrated in screen shot 300C, mission elements and instructions 311 change as the mission is being completed. When the mission is complete and authenticated, the content is unlocked, as shown in screen shot 300D, which shows the unlocked image 313. Alternatively, screen shot 300D may include playable audio or video files which have been unlocked according to the specific mission.

### User Authentication

In certain embodiments, the system generates a unique user ID for each end user who completes a mission. In one embodiment, this user ID may have a special parameter, such as: xxx=<missionId>|<userId>|<UUID-token>. The user of such parameters creates a private “key.”

In certain other embodiments, the system generates a campaign ID that identifies the private items. The system may also associate the userID as the authorized email recipient or user name (depending on the data field).

In certain other embodiments, a UUID token is generated so that when the page is opened, a message is automatically sent to the server, which authenticates the userID and provides access to the items in the missionID. The UUID-token has values that determine the number of uses prior to the token becoming usable (e.g. 5, 10 or unlimited).

### Examples of Verifaction Methods

The verification of mission actions by server 110 depends on the action and the platform on which the action was performed. As examples to how verification of individual actions is performed, verification of four different modes follows, as: 1) Website Action with Open API Validation; 2) Download a Binary File with Cryptographic Hash Function Validation; 3) e-Commerce transaction with API verification; and 4) Provide Personal Information direct to database.

Website Actions with Open API Validation

Many websites provide open APIs to authorize third-parties applications to access their users' information. For example, the API for Twitter may be found at https://dev.twitter.com/docs/api/1.1, and the API for Facebook may be found at https://developers.facebook.com/docs/graph-api.

To verify actions using Open API validation, server 110 may request that the user grant access to information from the website to validate that the action was performed. Thus, for example, if the action is “retweet a tweet,” the user is provided with a the URL of the tweet to retweet, for instance: https://twitter.com/Blazestage/status/449217623603949569. When the user tries to access the content, server 110 provides the user with two sequential buttons: “Retweet,” and then “Verify.” (See, for example, FIG. 3C). When the user presses “Retweet,” Twitter Web Intents ( https://dev.twitter.com/docs/intents) is used to allow the user to retweet the tweet. Next, when the user presses “Verify.” a Twitter OAuth window is opened, and the user is prompted to authorize server 100 to “Read tweets from your timeline.” See, for example, https://dev.twitter.com/docs/auth/using-oauth.

After the user authorizes server 110 to read their tweets, server 110 uses the user timeline API method to retrieve the collection of the most recent Tweets posted by the user, and then iterates through the tweets to find the tweet with the same “id” field as the tweet defined by the mission, and then also validates that the field “retweeted” is set to “true”. See, for example, https://dev.twitter.com/docs/api/1.1/get/statuses/user timeline for more details about the Twitter API used.

Download a Binary File with Cryptographic Hash Function Validation

This type of validation confirms that a use has stored a specific binary file on their computer. In one embodiment, a copy of the specific binary file is first provided to system 110, which then calculates and stored the hash value for the mission action file.

Validation is accomplished by the user providing a binary file on their computer to system 110, which then calculates the hash value of the provided file, and then compares the hash value to verify that the specific binary file has been stored on the user's computer.

E-Commerce Transaction with API Verifacation

This type of validation confirms that a user has made one or more specific purchases on an e-Commerce site. When an e-Commerce action is selected by the user, system 110 provides a form to the user requesting additional information to validate the transaction, such as a transaction id generated by the e-Commerce site after the order was placed, for instance—a shipping tracking number.

Thus, as one example, Amazon (http://www.amazon.com) provides an API that allows sellers to list the orders created during a time frame. See, for example, http://docs.developer.amazonservices.com/en_US/orders/2013-09-01/Orders_ListOrders.html. The API this returns the list of orders with information about each order, particularly the field “/Orders/Order/AmazonOrderld” which is displayed to the user after he places his order or when he reviews his order history.

Using the Amazon API, when the user executes this mission action, a dialog box is provided to the user prompting for the “Amazon Order #” (AmazonOrderld), which is then provided to server 110, which may determine whether the action has been completed by the user.

### Provide Personal Information Direct to Database

This type of validation confirms that a user has provided certain requested information to system 110. When the mission action requires the input of such information, system 110 requires that the user input data into certain data fields. If the user has previously provided such information to system 110, the information may be used to populate the data fields, and the data is revalidated.

### Alternative Embodiments

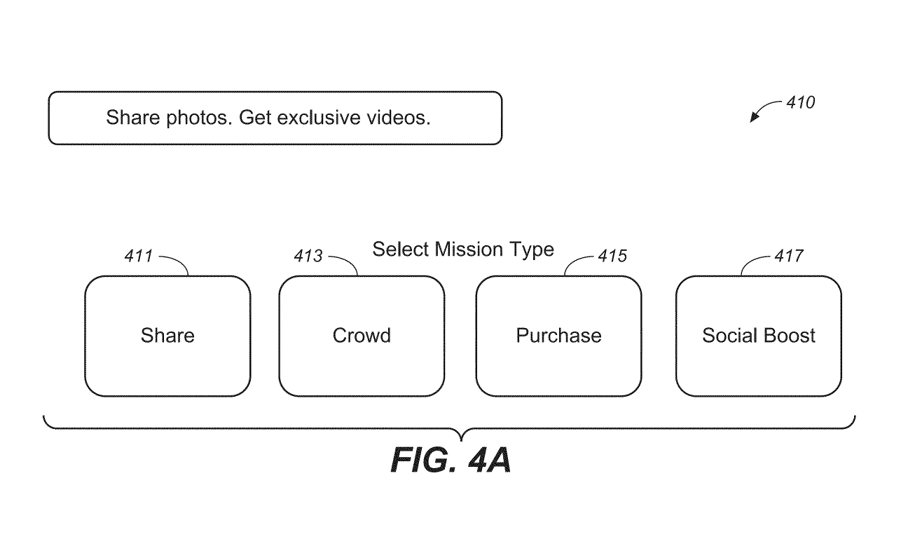

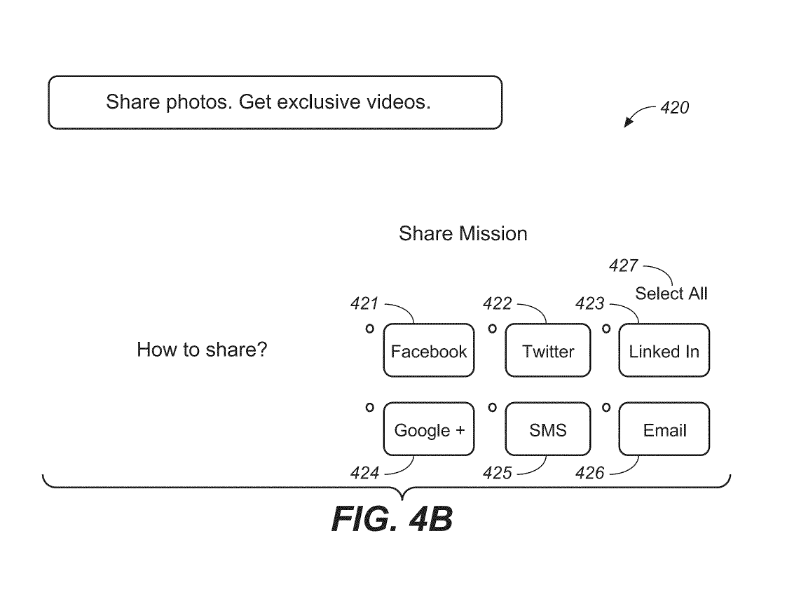

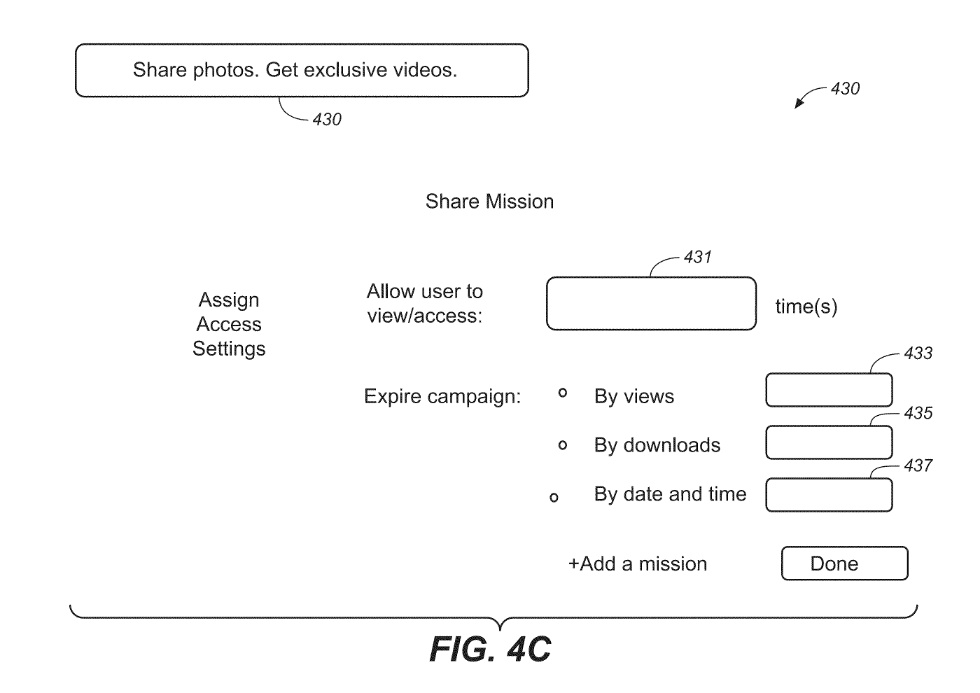

FIGS. 4A through 4C are screen shots illustrating embodiments that may be used in conjunction with the embodiment illustrated in FIGS. 2A-2I for an administrator to set up a mission. The steps illustrated in FIGS. 4A through 4C are generally the same as those illustrated in FIGS. 2A through 2I, except as explicitly stated.

FIG. 4A shows a screen shot 410 that prompts the administrator to define a step of a mission, which are categorized as a “Share,” a “Crowd,” a “Purchase,” or a “Social Boost” mission step, by pressing button 411, 413, 415, or 417, respectively.

A “Share” mission step may be, for example and without limitation, the act of sharing on a social media site, such as Facebook, Twitter, Linked In, or Google +, or via SMS, or an E-mail; a “Crowd” mission step may be, for example and without limitation, the act of having a certain number of unique uses share a page URL one or more times; a “Purchase” mission step may be, for example and without limitation, the act of buying merchandise on Amazon.com, or purchasing groceries at a physical Walmart Store; and a “Social Boost” mission step may be, for example and without limitation, the act of adding a restaurant review on Yelp.com. Other types of missions may include “Register” which requires that the user provide personal information, or “Survey” which requires that the user completes a survey.

As one example of the present invention, FIG. 4B illustrated the setting up of a “Share” mission by selecting button 411. As shown in screen shot 420 of FIG. 4B, the administrator is presented with a selection of one or more Share mission steps, shown for example and without limitation, as sharing by Facebook, Twitter, Linked In, Google +, SMS, or E-mail, by pressing one of buttons 421, 422, 423, 424, 425, or 426, respectively, or by pressing button 427 to select all of the listed Share mission steps.

Screen shot 430 of FIG. 4C illustrates constraints that an administrator may put on the provided content. Examples of such limitations include, but are not limited to, a number of times that a user has access to the content, which may be input in box 431, and whether the mission campaign expires based on a number of views of the content (input in box 433), on a number of downloads of the content (input in box 435), or on a specific date and time (input in box 437).

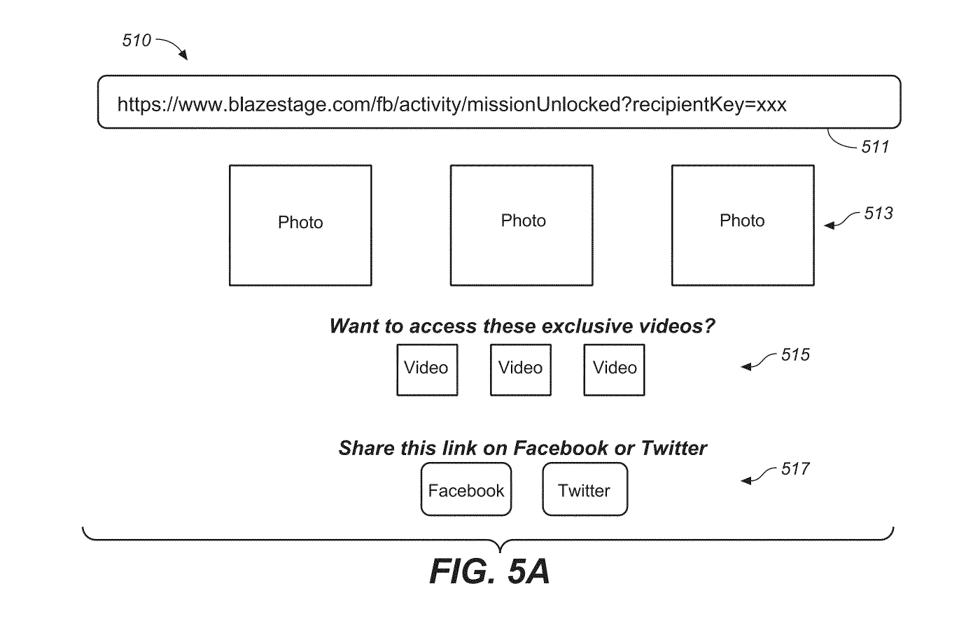

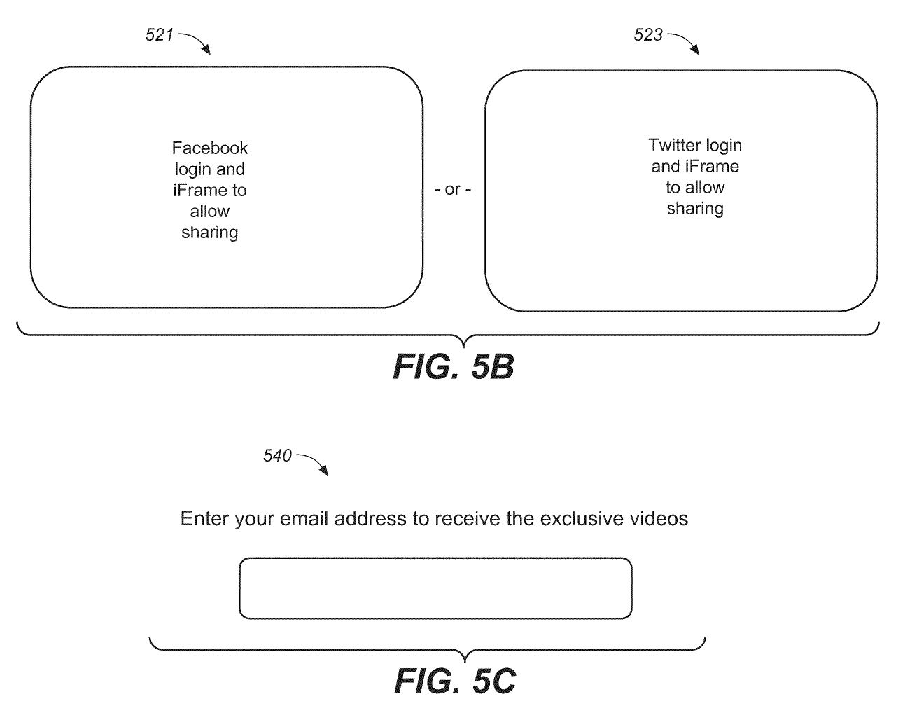

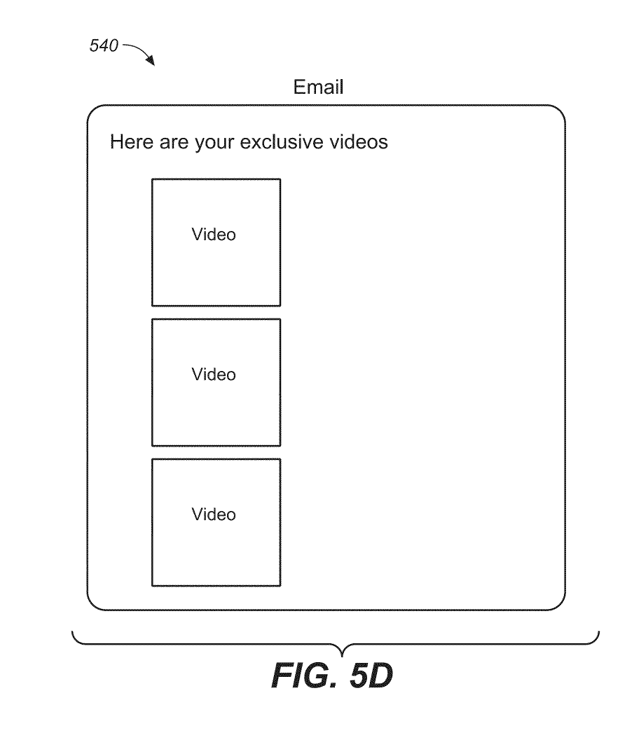

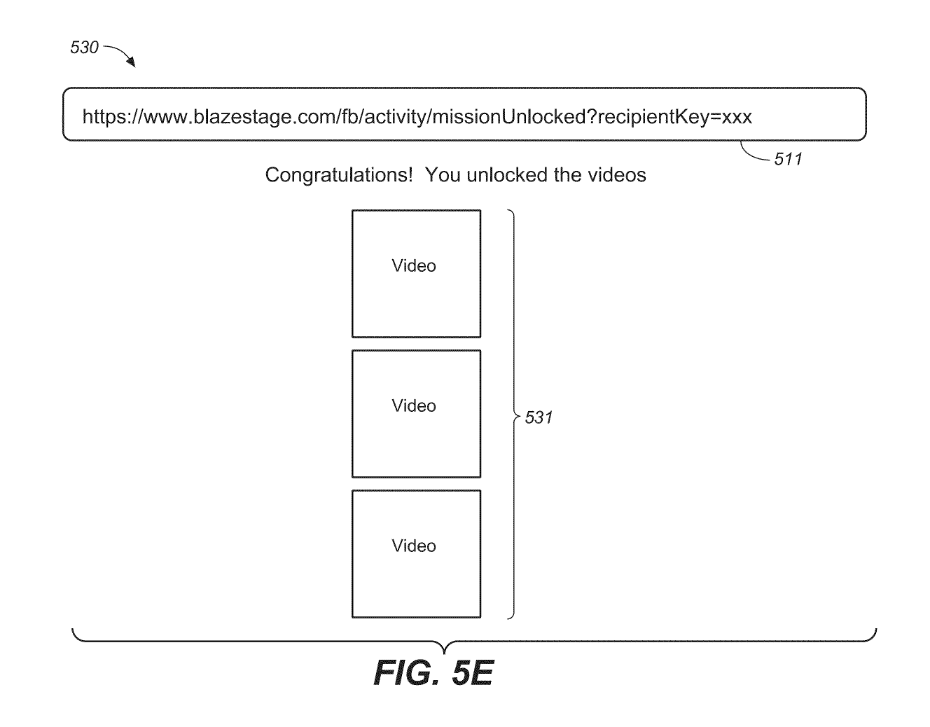

FIGS. 5A through 5E are screen shots illustrating embodiments that may be used in conjunction with the embodiment illustrated in FIGS. 3A-3D for a user to execute a mission and gain access to locked content. The steps illustrated in FIGS. 5A through 5E are generally the same as those illustrated in FIGS. 3A through 3D, except as explicitly stated.

Screen shot 510 of FIG. 5A is illustrative of a screen that is presented to a user. Box 511 includes the link that the user has followed for a particular mission. Several photos 513 are available to the user, while several videos 515 are indicated as being available to the user upon completion of a mission 517. The mission shown is that the user must share the link from box 411 by Facebook or Twitter.

FIG. 5B shows that the user is presented with screen shot 521, if the user has selected, from mission 517, to share on Facebook, or screen shot 523 if the user has selected to share using Twitter. The user may select, from screen shot 521 or 523 to login to the appropriate social networking site.

FIG. 5C shows a screen shot 530, wherein the mission has been completed and unlocked videos 531 are presented for downloading or viewing by the user.

FIGS. 5D and 5E illustrate another embodiment, wherein private content is provided to a user via E-mail. Thus, for example, screen shot 540 of FIG. 5D shows a prompt for the user's e-mail, and screen shot 550 of FIG. 5E shows the unlocked content being received as an e-mail by the user.

In other embodiment, the missions may be staged. That is, as a user completes additional steps, access is provided to additional content. In yet another embodiment, the staging may be cumulative among users. Thus, for example, when the total number of users completing the same mission reaches some predetermined goal, access is provided to all users that have completed a certain mission.

### EXAMPLES

The following are examples of various implementation of the present invention, and are discussed, for illustrative purposes but without limitation, as including the steps shown in FIGS. 5A through 5E. The following examples may include administrator selections which are not explicitly shown in the Figures, but which may be added to the software generating the screen shots as would be oblivious to one of ordinary skill in the art.

Example A: The administrator creates a mission to: “Share theses photos and get single-use access to these videos.” In this example, if the user shares the public link (URL) that contains items on Facebook or Twitter then they will acquire access, for a single-use only, to the private URL. This is illustrated in FIGS. 5A through 5C, where the user is provided initially with publically accessible photos 513, and is then provided, upon completion, with private links to unlocked videos 531.

The steps involved in this example are:
a) The administrator creates a new mission, which is titled “Share photos. Get exclusive videos.”
b) the administrator assigns a “Share” mission. The share mission requires two steps: 1) defining how the items should be shared—the user activity requirement; and 2) attaching two types of items—public items and private items.
c) the user selects share via: a) Facebook or b) Twitter.
d) the administrator adds five photo “items” to the public folder.
e) the administrator adds five video “items” to the private folder.
f) the administrator assigns “single use” as the accessibility setting.

Example B: The administrator adds an additional mission to an existing mission, which may be, for example, the mission of Example A. In this example if, after completing the share mission of Example A, which provides single-use access to the private items, the user completes a second mission, which in this case is the “registration” mission, and which requires the user complete a registration form, and which allow the user to gain unlimited access to the same private content.

The steps involved in this example are:
a) the administrator selects a previously created mission, such as the “Share photos. Get exclusive videos” mission of Example A.
b) the administrator is presented with the option and selects a second mission: “Register.” The “Register” mission requires that the user provide personal information by registering. The administrator selects one of two options: 1) get access to additional (new) private items, or 2) get different (extended) access to the existing private items.
c) the administrator is presented with the option and selects “extended access to the existing private items.”
d) the administrator assigns “unlimited use” as the accessibility setting.

Example C: The administrator creates a mission “If I can get 500 new Likes on Facebook, all of my Facebook fans will get to download the Preface to my new book, entitled ‘New Book.’” In this example, after 500 new Likes are attained for the mission, by all users that select that mission, a link will be provided to the users that allow download access, via providing download button, to the Preface of the new book, a PDF file, is automatically posted to the administrator's personal Facebook page.
a) The administrator creates a new mission, and adds a title “500 new likes. Download book Preface.”
b) The administrator assigns a “Crowd” mission. Assigning this mission requires 3 steps: 1) defining the required crowd activity; 2) Defining the crowd “quota”; and 3) depending on the required crowd activity, attaching the public and/or private items.
c) the administrator is presented with the option and selects Facebook Like as the required crowd activity.
d) the administrator is presented with the option and types in 500 into a data field to determine the crowd quota.
e) since the administrator selected Facebook Like as the required crowd activity, only private items need to be attached. If the administrator selected the “share” or “view” activity then both private and public items would need to be attached. the administrator attaches the Preface.pdf file to the private folder.
f) the administrator is presented with the option and assigns “single use” and “download button: yes” in the accessibility setting.
g) the administrator is presented with the option and expires the mission after 500 downloads.

One embodiment of each of the methods described herein is in the form of a computer program that executes on a processing system, e.g., a one or more processors that are part of a system Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. Steps may thus be added or deleted to methods described within the scope of the present invention.

I claim:

1. A method for use by an administrator to define a mission which, when completed by a user, delivers content to the user, said method including:
prompting the administrator to identify two or more actions to be performed on two or more platforms;
prompting the administrator to identify content to be provided to the user upon completion of said two or more actions; and
generating code that, when executed by the user,
prompts the user to perform said identified two or more actions,
verifies that the user has performed said identified two or more actions, and
provides the user with access to said identified content.

2. The method of claim 1, wherein one action of said two or more actions includes a social media action or an e-commerce action.

3. The method of claim 2, where said social media action is one or more of providing a Facebook like, Sharing on Facebook, a Follow on Twitter, a Retweet, and a hash tag.

4. The method of claim 2, where said e-commerce action is providing an authorization ID from a purchase receipt, a promotional code, or an iTunes purchase and download.

5. The method of claim 1, where one action of said two or more actions includes downloading, sharing, commenting, registering, or completing a poll or survey.

6. The method of claim 1, further comprising providing the generated code as an embed code that links to the prompting and providing steps.

7. The method of claim 1, where said content is an image file, an audio file, an image file, or a text producing file.

8. The method of claim 1, where one platform of said two or more platforms is a social networking site or an e-commerce site.

9. A method for verifying actions taken by a user comprising:
prompting a user to perform two or more actions on two or more platforms; and
verifying that the user has performed the two or more actions.

10. The method of claim 9, wherein one of said two or more actions includes a social media action or an e-commerce action.

11. The method of claim 10, where said social media action is one or more of providing a Facebook like, Sharing on Facebook, a Follow on Twitter, a Retweet, and a hash tag.

12. The method of claim 10, where said e-commerce action is providing an authorization ID from a purchase receipt, a promotional code, or an iTunes purchase and download.

13. The method of claim 9, where one action of said two or more actions includes downloading, sharing, commenting, registering, or completing a poll or survey.

14. The method of claim 9, where one platform of said two or more platforms is a social networking site or an e-commerce site.

15. The method of claim 9, where said verifying is one or more of verifying a website action using an Open API, verifying a the download of a binary file using hash function validation, verifying an e-Commerce transaction using API verification, or verifying that personal information has been provided to a database.

16. The method of claim 9, further comprising requesting that the user grants access to information from the website to validate that the action was performed.

17. A method for delivering content over a network comprising:
prompting a user to perform two or more actions on two or more platforms; and
providing content to the user after the user has performed the two or more actions.

18. The method of claim 17, wherein at least one of said two or more actions includes a social media action or an e-commerce action.

19. The method of claim 18, where said social media action is one or more of providing a Facebook like, Sharing on Facebook, a Follow on Twitter, a Retweet, and a hash tag.

20. The method of claim 18, where said e-commerce action is providing an authorization ID from a purchase receipt, a promotional code, or an iTunes purchase and download.

21. The method of claim 17, where said action is one or more of downloading, sharing, commenting, registering, or completing a poll or survey.

22. The method of claim 17, further comprising providing an embed code that links to the prompting and providing steps.

23. The method of claim 17, where said content is an image file, an audio file, an image file, or a text producing file.

24. The method of claim 17, where one platform of said two or more platforms is a social networking site or an e-commerce site.

25. The method of claim 17, where said providing content to the user after the user has performed the series of actions includes verifying that the user has performed the series of actions.
